(19) United States
(12) Patent Application Publication
(10) Pub. No.: US 2007/0274864 A1
(43) Pub. Date: Nov. 29, 2007

(54) Gas absorption testing system

(75) Inventors: Frank C. Wang, Annandale, NJ (US); Michael Siskin, Randolph, NJ (US)

Correspondence Address: ExxonMobil Research and Engineering Company, P. O. Box 900, Annandale, NJ, 08801-0900, US

(73) Assignee: ExxonMobil Research and Engineering Company

(21) Appl. No.: 11/803,049

(22) Filed: May 11, 2007

Related U.S. Application Data
(60) Provisional application No. 60/808,010, filed on May 23, 2006.

(51) Int. Cl. G01N 30/96

(52) U.S. Cl. 422/69; 422/78

(57) ABSTRACT

In the present invention, a gas absorption testing system is disclosed. This gas absorption testing system is used for testing the absorption, desorption and re-absorption properties of chemicals in a solution. A gas absorption reactor for passing gas through and absorbing material is disclosed. The testing procedures as well as the detailed analytical instrumentation used to accomplish these necessary tests are also described. More specifically, this apparatus is for measuring hydrogen sulfide/carbon dioxide absorption selectivities. The data for ethoxyethanol-t-butylamine (EETB) is provided as an example.

This application claims the benefit of U.S. Provisional application 60/808,010 filed May 23, 2006.

### BACKGROUND OF THE INVENTION

The present invention relates to a gas absorption testing system. In particular, the gas that is to be absorbed is hydrogen sulfide and/or carbon dioxide.

It is well known in the art to treat gases and liquids, such as mixtures containing acidic gases including CO₂, H₂S, CS₂, HCN, COS and oxygen and sulfur derivatives of C₁ to C₄ hydrocarbons with amine solutions to remove the acidic gases. The amine usually contacts the acidic gases and the liquids as an aqueous solution containing the amine in an absorber tower with the aqueous amine solution contacting the acidic fluid counter currently.

The treatment of acid gas mixtures containing, inter alia, CO₂ and H₂S with amine solutions typically results in the simultaneous removal of substantial amounts of both the CO₂ and H₂S.

After contacting the normally gaseous mixture with the absorbent solution, which becomes saturated or partially saturated with H₂S, the solution may be at least partially regenerated so that it may be recycled back to the absorber. As with absorption, the regeneration may take place in a single liquid phase. Regeneration or desorption of the acid gases from the absorbent solution may be accomplished by conventional means such as pressure reduction of the solution, increase of temperature to a point at which the absorbed H₂S flashes off, or both, or by passing the solution into a vessel of similar construction to that used in the absorption step, at the upper portion of the vessel, and passing an inert gas such as air or nitrogen or preferably steam upwardly through the vessel. The temperature of the solution during the regeneration step should be in the range from about 50° to about 170° C., and preferably from about 80° to 120° C., and the pressure of the solution on regeneration should range from about 0.5 to 100 psia, preferably 1 to about 50 psia. The absorbent solution, after being cleansed of at least a portion of the H₂S gas, may be recycled back to the absorbing vessel. Makeup absorbent may be added as needed.

However, it is desirable to test the absorbing solution before it is placed in commercial use.

### SUMMARY OF THE PRESENT INVENTION

In the present invention, a gas absorption testing system is disclosed. This gas absorption testing system is used for testing the absorption, desorption and re-absorption properties of chemicals in a solution. A gas absorption reactor for passing gas through an absorbing material is disclosed. The testing procedures as well as the detailed analytical instrumentation used to accomplish these necessary tests are also described. More specifically, this apparatus is for measuring hydrogen sulfide/carbon dioxide absorption selectivities. The data for ethoxyethanol-t-butylamine (EETB) is provided as an example.

The advantages of this gas absorption testing system compared with prior art or present commercial practices are:

1) much less sample (chemicals) is required to do the test (less then 0.5 gram of chemicals dissolved in water). This permits smaller scale synthesis of new chemicals to be tested.

2) micro-liter sample size is required to do the analytical measurement. The volume for the measurement is thereby less 0.2% preferably less than 0.1% of the solution so the system is not disturbed during the analytical measurement.

3) analytical measurement are based on gas chromatography (GC) with thermal conductivity detector (TCD) and sulfur chemiluminescence detector (SCD) technologies which have proven precision and accuracy for all the absorption properties.

This gas absorption testing system solves sample availability problems during the candidate screening process, solves the sampling problem during the testing and solves the precision and accuracy problem during the analytical measurement.

The present invention requires:

1) Tenths of a gram of samples to do the test. Therefore, synthesis of this amount of chemical is much less costly and time consuming. This overcomes the first bottleneck of a development.

2) During the test, if large amounts of testing solution are required to do the necessary analytical measurement, the system will be disturbed, making the testing system parameter less accurate for the further testing.

3) The analytical measurement based on this invention results in higher precision and accuracy.

In order to identify and test chemicals suitable for industrial gas treating applications, an effective and efficient testing system is desired. This new system can greatly reduce the current hurdles and barriers to speed up the screening of chemicals to identify and find appropriate candidates for specific applications.

### BRIEF DESCRIPTION OF THE DRAWINGS

FIG. 1a is a schematic diagram of the testing system.

FIG. 1b is a schematic diagram of the gas absorption reactor.

FIG. 2 shows a schematic diagram of a preferred embodiment of the testing system.

FIG. 3 shows the chromatogram of the incoming gas mixture.

FIG. 4 shows the chromatogram of the solution gas contest after the absorption test.

FIG. 5 shows the chromatogram of the solution gas content after the desorption test.

FIG. 6 shows the chromatogram of the solution gas content after the re-absorption test.

### DETAILED DESCRIPTION OF THE PREFERRED EMBODIMENTS

### The Gas Absorption Testing System—Gas Flow and Absorption Reactor

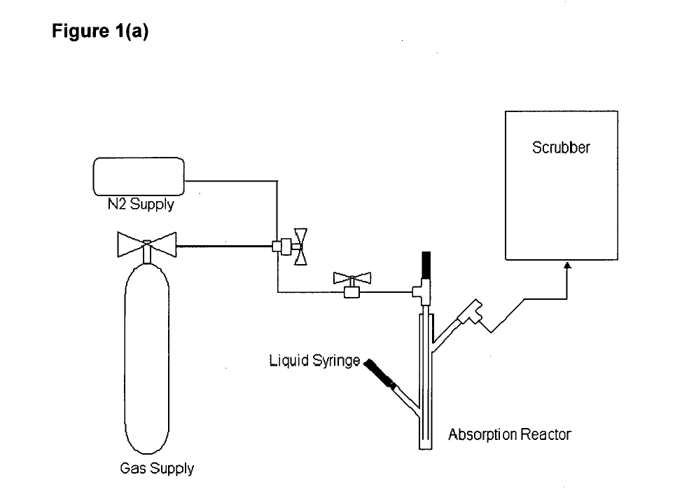

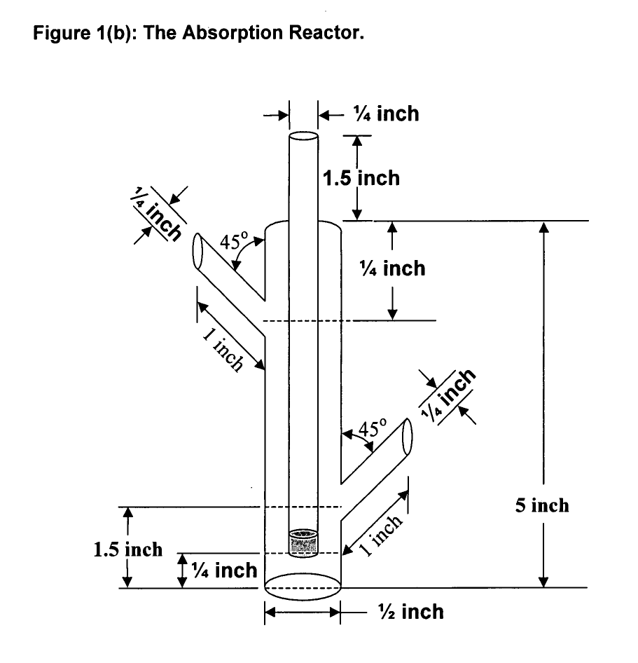

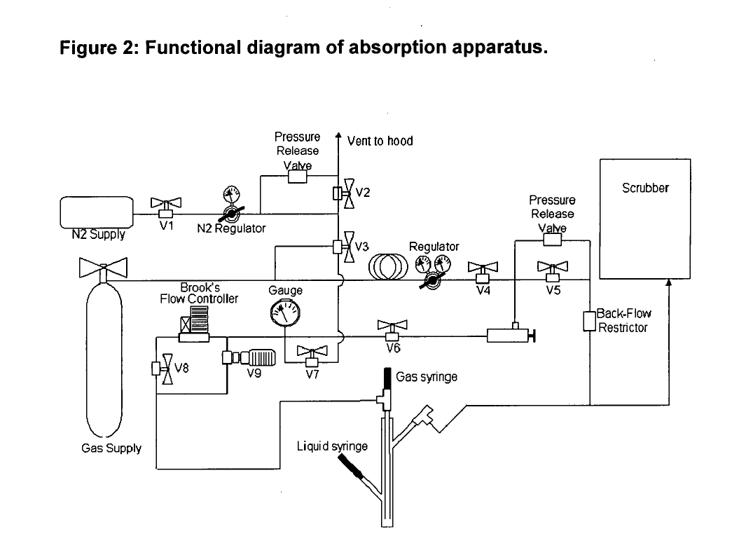

FIG. 1a shows a schematic diagram of the gas absorption testing system of this invention which contains a gas flow section and an absorption reactor, 2. The gas flow section includes a source of N₂, a gas supply, and a scrubber. FIG. 2 shows a more detailed schematic diagram of the testing system including all the safety valves. The test gas mixture flow from the tank through a regulator, passes through the valve V4. After valve V4, a pressure release valve is in-line to prevent any unexpected high pressure build-up from the tank. Any pressure higher than pre-set limit will trigger this valve to open to directly release excess pressure/flow to scrubber. The manual pressure release route with valve V5 is also included to manually release the test gas mixture to scrubber. The normal test gas flow after valve V4 then passes through a one-way flow through valve and then through valve V6 to the cross point with the gauge to indicate the pressure of the flow. After the cross point, the flow to the absorption reactor has been set-up in two parallel ways. One route passes through an electronic controlled flow meter to pre-set the rate of flow with valve V8 to gate the flow. The other way it passes through a manually adjusted needle valve to setup a rate of flow. During the desorption test, the nitrogen gas is flowed through the reactor to promote desorption of the test gas from the solution. The laboratory supplied nitrogen flow goes through valve V1; pass the regulator to a branch point. One branch is set-up with a pressure release valve to vent to prevent any un-expected high pressure flow. The other branch includes a manual pressure release route through valve V2 to vent and another route to a three-way valve V3. One opening of valve V3 is connected to a test gas line to perform the test gas line clean-up after a test; the other opening of valve V3 is connected to valve V7 and then to the cross point to replace the test gas flow to the absorption reactor during the desorption test. The gas flow out of the absorption reactor toes directly to the scrubber. During the absorption/desorption/reabsorption tests, a gas syringe is used in the incoming gas line to the absorption reactor to measure the incoming test gas composition. A liquid syringe is used in the lower portion of the absorption reactor to sample the gas absorbed in the solution.

The chemical to be tested is placed in the absorption reactor either in the pure form or in a solution. Aqueous solution is preferred, but non-aqueous, e.g. sulfolane, and mixed aqueous-non-aqueous solutions may be used. The appropriate test gas (pure gas or a mixture of gases is released from the gas supply cylinder and flows through a well designed delivery system to the absorption reactor with all regulators and safety valves to make sure there is complete control of flow and pressure. The gas enters the inner tube of the reactor and bubbles through the outer solution. During the test, the absorption reactor is in a thermostated circulated solution bath to control the absorption reaction temperature. A magnetic stirring bar (not shown in Figures) is placed in the bottom of the absorption reactor to make sure the testing solution is well mixed during the test. The test parameters such as the length of flow, the rate of flow, and the concentration of the solution depend on the design of the test which in turn is related to the purpose of the testing and type of application.

### The Gas Absorption Reactor

FIG. 1b shows a diagram of a gas absorption reactor. The design consideration is based on (1) minimization of the reaction solution required, (2) maximization of the contact surface and contact time between gas and solution, (3) easy control of the reaction environment such as the absorption reaction temperature and (4) easy sampling both of incoming gas as well as the solution during the test. The absorption reactor in FIG. 2 meets all the requirements described above and is much more effective and efficient compared with previous generation absorption measuring equipment.

### EXAMPLE

### Test of Ethoxyethanol-t-Butylamine (EETB) for Absorption, Desorption, and Re-Absorption of Hydrogen Sulfide (H₂S)

An example using the gas absorption testing system of this invention is given to demonstrate the efficiency and effectiveness.

### Absorption Test

1) EETB (242 mg) is used to prepare a 0.15 M, 10 mL aqueous solution.

2) A 3 mL aliquot of the solution is placed in the absorption reactor. The reactor is placed into a circulated bath at 35° C. for absorption test.

3) A test gas mixture (89% N₂, 10% CO₂, and 1% H₂S) is flowed at 4.2 mL per minute through the test solution for 2 hours.

4) During the test, a sample of test gas mixture, 1 μl to 5 μl (1 mg to 5 mg), is collect by a gas-sampling syringe, and a gas chromatograph with a thermal conductivity detector (GC/TCD) is used to analyze the composition of this gas mixture.

5) Table 1 lists the test specifications of the GC/TCD.

6) After 2 hours of the absorption test, a 3 μL sample of liquid solution is collected. The same GC/TCD is used to analyze the content of CO₂ and H₂S.

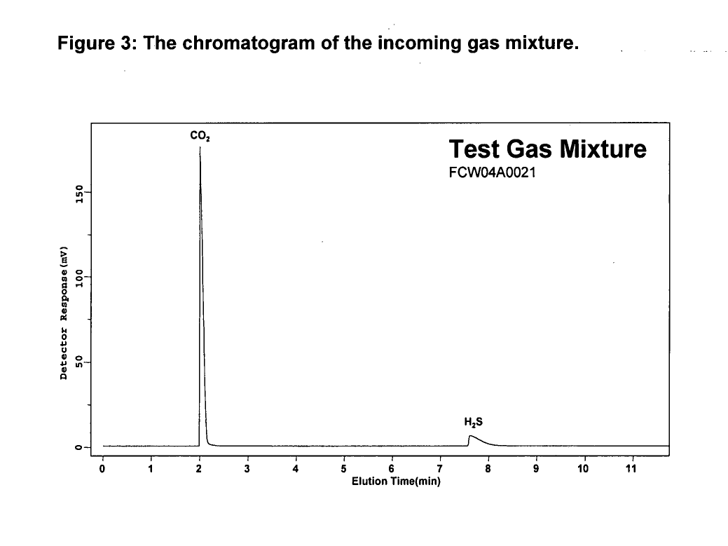

7) FIG. 3 shows the chromatogram of incoming gas mixture.

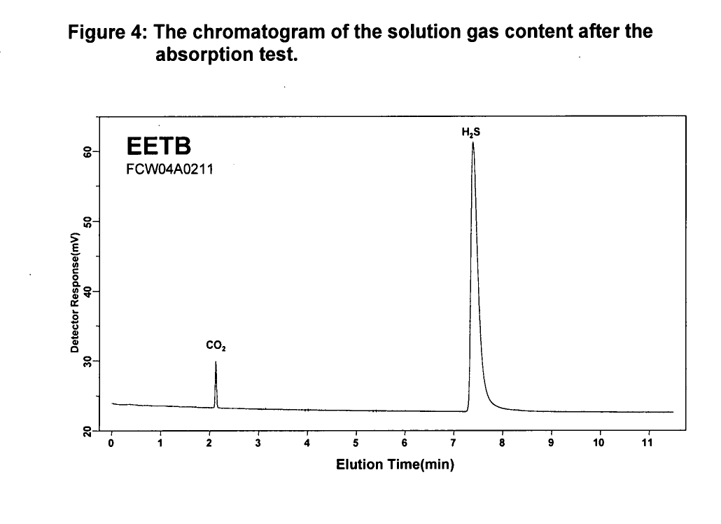

8) FIG. 4 shows the chromatogram of solution gas content after the absorption test.

9) Table 2 presents the definition of selectivity and the details of the analytical instrumentation.

### Desorption Test

10) The solution after the absorption test will be used for the desorption test.

11) The gas mixture is replaced by a nitrogen gas flow with the same flow rate through the absorption reactor.

12) The circulated bath temperature is increased from 35° C. to 85° C.

13) The desorption test is continued for 2 hours. After 2 hours of desorption, a 3 μL sample of liquid solution is collected. The same GC/TCD is used to analyze the content of CO₂ and H₂S.

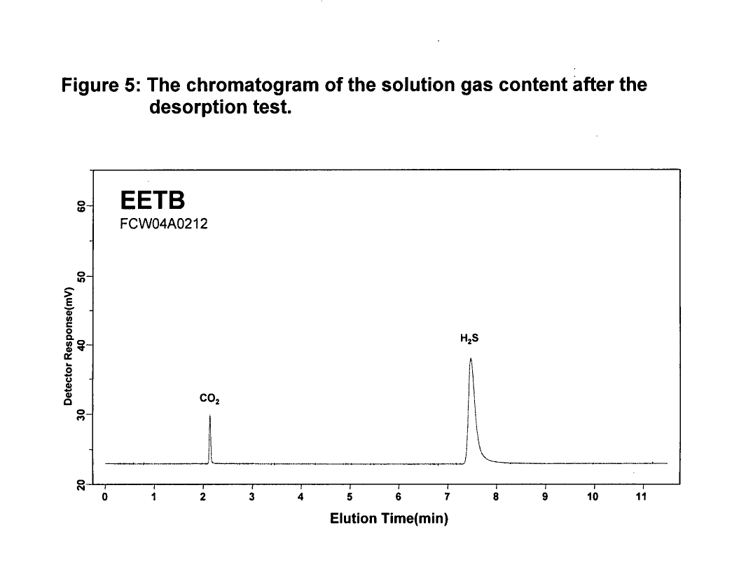

14) FIG. 5 shows the chromatogram of the gas content of the solution after the desorption test.

### Re-Absorption Test

15) The solution after the desorption test will be used for the re-absorption test.

16) The nitrogen gas flow is replaced with the previous N₂, H₂S, CO₂ gas mixture flow with the same flow rate through the absorption reactor.

17) The circulating bath temperature is lowered from 85° C. to 35° C.

18) The test is continued for 2 hours. After 2 hours of the re-absorption test, a 3 μL sample of liquid solution is collected. The same GC/TCD is used to analyze the content of CO₂ and H₂S.

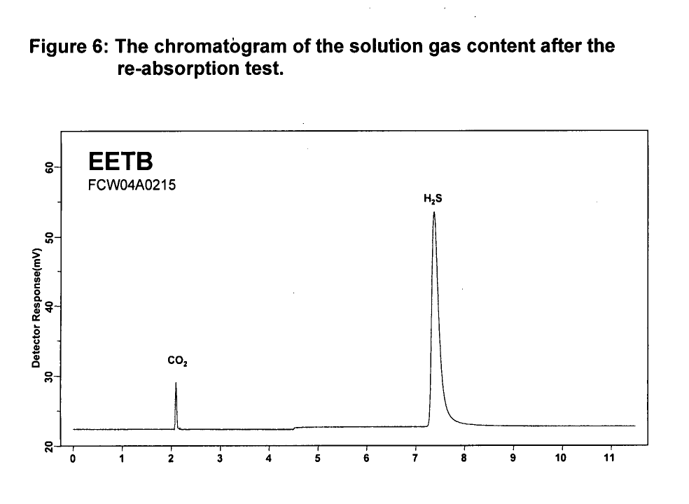

19) FIG. 6 shows the chromatogram of the solution gas content after the re-absorption test.

20) Table 3 presents the definition of Capacity and the details of the analytical instrumentation.

21) A 0.15 M propyl mercaptan solution is prepared as a reference concentration standard.

22) A 1 mL solution, after the re-absorption test, is mixed with an equal volume of the reference standard solution.

23) A 1 μL sample of mixed solution is collected and analyzed with a gas chromatograph with a sulfur chemiluminescence detector (GC/SCD) to determine the composition of this gas mixture.

24) Table 4 presents the definition of Loading and the details of the analytical instrumentation.

25) Table 5 shows the test results for the ethoxyethanol-t-butylamine (EETB).

TABLE 1
The test specifications of the GC/TCD.

| Test Conditions: | |
|---|---|
| GC Instrument: | Agilent 5890GC |
| Split/Split ness Inlet: | |
| Head Pressure: | 2.4 psi |
| Temperature: | 250° C. |
| Split Ratio: | 20:1 |
| Capillary Column: | SUPELCO CARBOXEN 1006 PLOT |
| Length: | 30 meter |
| I.D.: | 0.53 mm |
| Oven Temperature Program: | 50° C./11.50 min-30° C./min- |
| | 200° C./3.5 min |
| TC Detector: | |
| Data Acquisition Method: | 0415 |
| Data Analysis Method: | 0415 |

TABLE 2
The definition of selectivity and the details of the analytical
instrumentation.

$Selectivity = \frac{( \frac{[ {H}_{2} S ]}{[ C {O}_{2} ]} ) in Solution}{( \frac{[ {H}_{2} S ]}{[ C {O}_{2} ]} ) in Feed Gas}$
Measured by a GC/TCD system
Experiment Conditions:
GC Instrument: Agilent 5890GC
Split/Splitness Inlet:
Head Pressure: 2.4 psi
Temperature: 250° C.
Split Ratio: 20:1
Capillary Column: SUPELCO CARBOXEN 1006 PLOT
Length: 30 meter
I.D.: 0.53 mm
Oven Temperature Program: 50° C. /11.50 min - 30° C./min -
200° C./3.5 min
TC Detector:
Data Acquisition Method: 0415
Data Analysis Method: 0415

TABLE 3
The definition of Capacity and the details of the analytical
instrumentation.

$Capacity = \frac{Absorption {H}_{2} S - Desorption {H}_{2} S}{Absorption {H}_{2} S}$
Measured by a GC/TCD system
Experiment Conditions:
GC Instrument: Agilent 5890GC
Split/Splitness Inlet:
Head Pressure: 2.4 psi
Temperature: 250° C.
Split Ratio: 20:1
Capillary Column: SUPELCO CARBOXEN 1006 PLOT
Length: 30 meter
I.D.: 0.53 mm
Oven Temperature Program: 50° C./11.50 min - 30° C./min -
200° C./3.5 min
TC Detector:
Data Acquisition Method: 0415
Data Analysis Method: 0415

TABLE 4
The definition of Loading and the details of the analytical
instrumentation.

$Loadiing = \frac{Moles of {H}_{2} S}{Moles of Amine}$
Measured by a GC/SCD system
Experiment Conditions:
GC Instrument: Agilent 5890GC
Split/Splitness Inlet:
Head Pressure: 25 psi
Temperature: 300° C.
Split Ratio: 20:1
Capillary Column: SUPELCO SPB-1 Sulfur
Length: 60 meter
I.D.: 0.32 mm
Thickness: 4.0 μm
Oven Temperature Program: 40° C./5 min - 5° C./min -
300° C./3 min
SC Detector:
Temperature: 800° C.
H2 Flow: 100 mL/minute
Air Flow: 40 mL/minute
Data Acquisition Method: 1601
Data Analysis Method: 1601

TABLE 5
The test results for Ethoxyethanol-t-butylamine (EETB).

Selectivity: 15.4
Loading: 16.25%
Capacity: 60%
Re-Sel.: 13.26
Compound Tested:

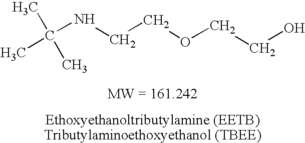

Experiment Conditions:
1. 0.15 M Aqueous Solution
2. Test Gas Mixture are: 89% N2, 10% CO2 and 1% H2S
3. Gas Mixture Flow at 4.2 mL/minute
4. Absorption temperature at 35° C.
5. Desorption temperature at 85° C.

In this invention, a gas absorption testing system is described. This gas absorption testing system is used for testing chemicals to explore their absorption, desorption and re-absorption properties in the solution. The design and the set-up of the gas absorption reactor are disclosed. The testing procedures as well as the detailed analytical instrumentation used to accomplish the necessary tests are also described. The test data using ethoxyethanol-t-butylamine (EETB) as an example of a tested chemical is demonstrated.

The advantages of this gas absorption testing system compared with prior art or present commercial practices are:

1) much less sample (chemicals) is required to do the test (less then 0.5 gram). This makes the synthesis of new chemicals much easier.

2) micro-liter sample size is required to do the analytical measurement, which volume for the measurement is less than 0.1% of the solution and therefore, the system is not disturbed during the analytical measurement.

3) Analytical measurements are based on gas chromatography (GC) with a thermal conductivity detector (TCD) and a sulfur chemiluminescence detector (SCD). These technologies have proven precision and accuracy for all the absorption properties.

What is claimed is:

1. A gas absorption testing system comprising:
a) an absorption reactor including a reaction solution to be tested for gas absorption that allows gas to pass through the reaction solution,
b) a gas flow section including an absorption test gas supply, a desorption test gas supply, a re-absorption gas supply, a scrubber, a gas delivery system that alternately connects the absorption test gas supply, the desorption test gas supply, and the re-absorption test supply, to the absorption reactor and that connects the absorption reactor to the scrubber.

2. The gas absorption testing system wherein the absorption test supply and the re-absorption gas supply are the same gas supply.

3. The gas absorption testing system of claim 1 wherein said absorption reactor includes a syringe to withdraw less than (1 mg to 5 mg) to be analyzed.

4. The gas absorption testing system of claim 1 wherein said absorption reactor includes a syringe to withdraw less than 0.1% of the solution.

5. The gas absorption testing system of claim 1 wherein said absorption reactor includes a minimum of reaction solution and maximization of contact surface between gas and reaction solution.

6. The gas absorption testing system of claim 1 wherein said reaction solution is stirred with a magnetic stir bar to enhance the liquid-gas contact and solution uniformity.

7. The gas absorption testing system of claim 1 wherein said absorption reactor includes two concentric cylinders wherein one cylinder contains the reaction solution, the absorption test gas and the desorption test gas pass from the inner cylinder to the cylinder containing the reaction solution.

8. The gas absorption testing system of claim 4 wherein the inner cylinder contains a frit to convert the flow of test gas stream to a stream of small bubbles to increase the contact surface between test gas and solution.

9. The gas testing system of claim 2 wherein said absorption reactor includes a material to cause the absorption test gas and the desorption test gas to bubble through the reaction solution.

10. The gas absorption testing system of claim 1 wherein the absorption test gas includes hydrogen sulfide and/or carbon dioxide.

11. The gas absorption testing system of claim 1 wherein said desorption test gas is an inert gas.

12. The gas absorption testing system of claim 8 wherein said inert gas is nitrogen.

13. The gas absorption testing system of claim 1 wherein the temperature of the absorption reactor is controlled by a thermostated circulated solution bath to control the reaction temperature in varies steps.

14. The gas absorption testing system of claim 10 wherein the temperature of the absorption gas and re-absorption gas is maintained between 25° C. to 50° C. during passage through the absorption reator.

15. The gas absorption testing system of claim 10 wherein the temperature of the desorption test is controlled between 80° C. to 98° C. during passage through the absorption reactor.

16. The gas absorption testing system of claim 1 wherein the rate of test gas flow is controlled by gas flow meters, such that the flow may be varied between 2 to 50 mL per minute.

17. The gas absorption testing system of claim 1 further comprising a gas chromatograph.
